(19) United States
(12) Patent Application Publication
(10) Pub. No.: US 2015/0142729 A1
(43) Pub. Date: May 21, 2015

(54) PHOTO FILE DISPLAYING METHOD AND DLNA SYSTEM

(71) Applicant: Primax Electronics Ltd., Taipei (TW)

(72) Inventor: JUNG-CHANG YANG, Taipei (TW)

(73) Assignee: Primax Electronics Ltd., Taipei (TW)

(21) Appl. No.: 14/175,211

(22) Filed: Feb. 7, 2014

(30) Foreign Application Priority Data
Nov. 15, 2013 (TW) 102141705

(51) Int. Cl. G06F 17/30

(52) U.S. Cl. CPC G06F 17/30345
USPC 707/609

(57) ABSTRACT

A photo file displaying method includes the following steps. Firstly, a judging step is performed to judge whether a coordinate data of a photo file in a first electronic device is acquired. According to a result of acquiring the coordinate data, a location information or a no available location information is written into a data field of a metadata of the photo file. Then, a first virtual folder and a second virtual folder are displayed on a second electronic device. If the first virtual folder is selected, the photo file corresponding to the first virtual folder is displayed on the second electronic device. If the photo file has the location information, the photo file is assigned to the first virtual folder. If the photo file has the no available location information, the photo file is assigned to the second virtual folder.

### FIELD OF THE INVENTION

The present invention relates to a photo file displaying method, and more particularly to a photo file displaying method for a Digital Living Network Alliance (DLNA) system.

### BACKGROUND OF THE INVENTION

Generally, an area network system comprises a local area network (LAN) system, a metropolitan area network (MAN) system and a wide area network (WAN) system. With increasing development of science and technology, the area network system further comprises a universal plug and play (UPnP) system and a Digital Living Network Alliance (DLNA) system. For example, the DLNA system is an alliance organization that is composed by the manufacturers of consumer electronics products, mobile phones and computers. The DLNA is responsible for defining unified transmission specifications to allow a variety of products from different manufacturers to be connected and communicated with each other. Consequently, a first electronic device and a second electronic device that comply with the DLNA protocol can be in direct communication with each other in order to transfer data or make synchronization actions.

First of all, some architectures of the DLNA system will be illustrated as follows. FIG. 1 schematically illustrates the architecture of a first conventional DLNA system. As shown in FIG. 1, the first conventional DLNA system 1 comprises a network router 10, a digital media server (DMS) 11, and a digital media player (DMP) 12. The network router 10 is connected to an internet (not shown). In addition, the network router 10 is in communication with the digital media server 11 and the digital media player 12. Consequently, the communication between the digital media server 11 and the digital media player 12 is established through the network router 10. The digital media server 11 comprises a first storage element 111 for storing a media file 15. The media file 15 is for example an audio file, a photo file or a video file. After the digital media player 12 is in communication with the digital media server 11, the digital media player 12 may search the media file 15 from the digital media server 11. After the media file 15 is selected by the user through the digital media player 12, the media file 15 is transmitted from the digital media server 11 to a second storage element 121 of the digital media player 12. After the media file 15 is received by the digital media player 12, the media file 15 that is temporarily stored in the second storage element 121 can be played by the digital media player 12.

FIG. 2 schematically illustrates the architecture of a second conventional DLNA system. As shown in FIG. 2, the second conventional DLNA system 2 comprises a network router 20, a digital media server (DMS) 21, and a digital media renderer (DMR) 23. The communication between the digital media server 21 and the digital media renderer 23 is established through the network router 20. Similarly, the digital media server 21 comprises a first storage element 211 for storing a media file 25. In addition, the digital media server 21 further provides a control function of controlling operations of the digital media renderer 23. The digital media renderer 23 is used for receiving and playing the media file 25 that is transmitted from the digital media server 21. After the control function of the digital media server 21 is utilized to select the stored media file 25 from the digital media server 21, the media file 25 is transmitted from the digital media server 21 to the digital media renderer 23. Consequently, the media file 25 can be played by the digital media renderer 23.

FIG. 3 schematically illustrates the architecture of a third conventional DLNA system. As shown in FIG. 3, the third conventional DLNA system 3 comprises a network router 30, a digital media server (DMS) 31, a digital media renderer (DMR) 33, and a digital media controller (DMC) 34. The communication between the digital media server 31, the digital media renderer 33 and the digital media controller 34 is established through the network router 30. The digital media server 31 comprises a first storage element for storing a media file 35. The digital media renderer 33 is used for receiving and playing the media file 35 that is transmitted from the digital media server 31. The digital media controller 34 provides a control function. After the control function of the digital media controller 34 is utilized to select the stored media file 35 from the digital media server 31, the media file 35 is transmitted from the digital media server 31 to the digital media renderer 33. Consequently, the media file 35 can be played by the digital media renderer 33.

As mentioned above, the digital media server, the digital media controller, the digital media renderer and the digital media player included in the same DLNA system may transfer or play media files through the network router. The digital media server and the digital media renderer may be referred as passive electronic devices that can be controlled. Moreover, the digital media controller and the digital media player may be referred as active electronic devices that can control the passive electronic devices. For example, a user in a living room may allow a mobile phone to be connected to a computer host in a study room. Moreover, through the mobile phone, the user may browse the audio files in the computer and select a desired audio file from the computer. Then, the selected audio file is transmitted from the mobile phone to a stereo device in the living room. After the audio file is received by the stereo set, the audio file is played by the stereo device. Consequently, the purposes of conveniently and quickly sharing media contents can be achieved by the DLNA system.

In case that the first storage element of the digital media server stores a great number of media files, it is difficult to search the desired media file. For example, if the user intends to play the media file of the digital media server through the use of the digital media controller or the digital media player, since the number of the media files is too large, the desired media file to be played cannot be easily searched by the user. For facilitating the user to search the desired media file, at least three folders have been previously stored in the first storage element of the commercially available digital media server. The at least three folders comprise an audio folder corresponding to the audio files, a photo folder corresponding to the photo files and a video folder corresponding to the video files. When an audio file is newly added to the digital media server, the audio file is automatically assigned to the audio folder. Similarly, when a photo file and a video file are newly added to the digital media server, the photo file is automatically assigned to the photo folder and the video file is automatically assigned to the video folder.

However, since the number of the photo files is much larger than the number of the video file and the number of the audio files, the single photo folder of the first storage element usually stores a great number of photo files. Consequently, if the user intends to play the media file of the digital media server through the use of the digital media controller or the digital media player, it is still difficult for the user to search the desired media file from the photo folder.

Therefore, there is a need of providing a photo file displaying method for facilitating the user to view photo files and a DLNA system for displaying the photo files.

### SUMMARY OF THE INVENTION

An object of the present invention provides a photo file displaying method for facilitating the user to view photo files.

Another object of the present invention provides a DLNA system for displaying the photo files.

In accordance with an aspect of the present invention, there is provided a photo file displaying method for a DLNA system. The photo file displaying method includes the following steps. Firstly, a judging step is performed to judge whether a coordinate data of a photo file in a first electronic device is acquired. According to a result of acquiring the coordinate data, a location information or a no available location information is written into a data field of a metadata of the photo file. Then, a first virtual folder and a second virtual folder are displayed on a second electronic device. If the photo file has the location information, the photo file is assigned to the first virtual folder. If the photo file has the no available location information, the photo file is assigned to the second virtual folder. Moreover, if the first virtual folder or the second virtual folder is selected, the photo file corresponding to the first virtual folder or the second virtual folder is displayed on the second electronic device.

In accordance with another aspect of the present invention, there is provided a DLNA system for displaying a photo file. The DLNA system includes a network router, a digital media server, and an electronic device. The network router provides a network connection function. The digital media server is connected to the network router through network connection and storing the photo file. The digital media server includes a storage element, a data acquisition module and a controlling unit. The storage element is disposed within the digital media server. The photo file is stored in the storage element. The data acquisition module is connected with the storage element so as to acquire a coordinate data of the photo file. The controlling unit is connected with the data acquisition module. The controlling unit writes a location information or a no available location information into a metadata of the photo file according to a result of acquiring the coordinate data by the data acquisition module. If the photo file has the location information, the photo file is assigned to a first virtual folder. If the photo file has the no available location information, the photo file is assigned to a second virtual folder. The electronic device is connected to the network router through network connection and connected to the digital media server via the network router through network connection. The first virtual folder and the second virtual folder are displayed on the electronic device. If the first virtual folder or the second virtual folder is selected, the photo file corresponding to the first virtual folder or the second virtual folder is displayed on the second electronic device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a first conventional DLNA system;

FIG. 2 schematically illustrates the architecture of a second conventional DLNA system;

FIG. 3 schematically illustrates the architecture of a third conventional DLNA system;

FIG. 4 is a schematic functional block diagram illustrating a DLNA system according to a first embodiment of the present invention;

FIGS. 5A and 5B are a flowchart illustrating a photo file displaying method according to an embodiment of the present invention;

FIG. 6 is a table indicating the metadata of the plural photo files of the DLNA system of the present invention;

FIG. 7 schematically illustrates the folder architecture of the digital media server of the DLNA system according to the first embodiment of the present invention; and

FIG. 8 is a schematic functional block diagram illustrating a DLNA system according to a second embodiment of the present invention.

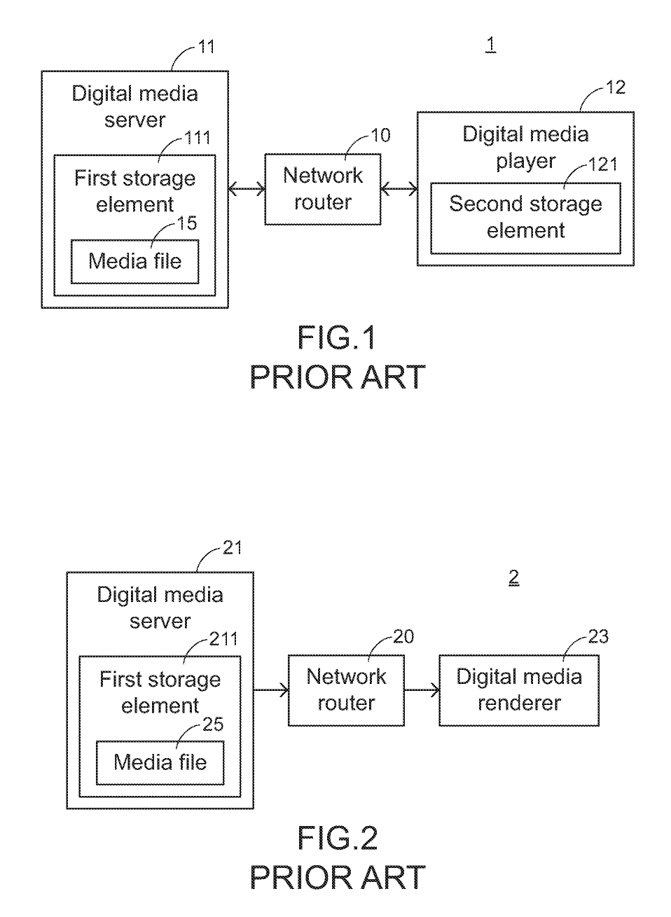

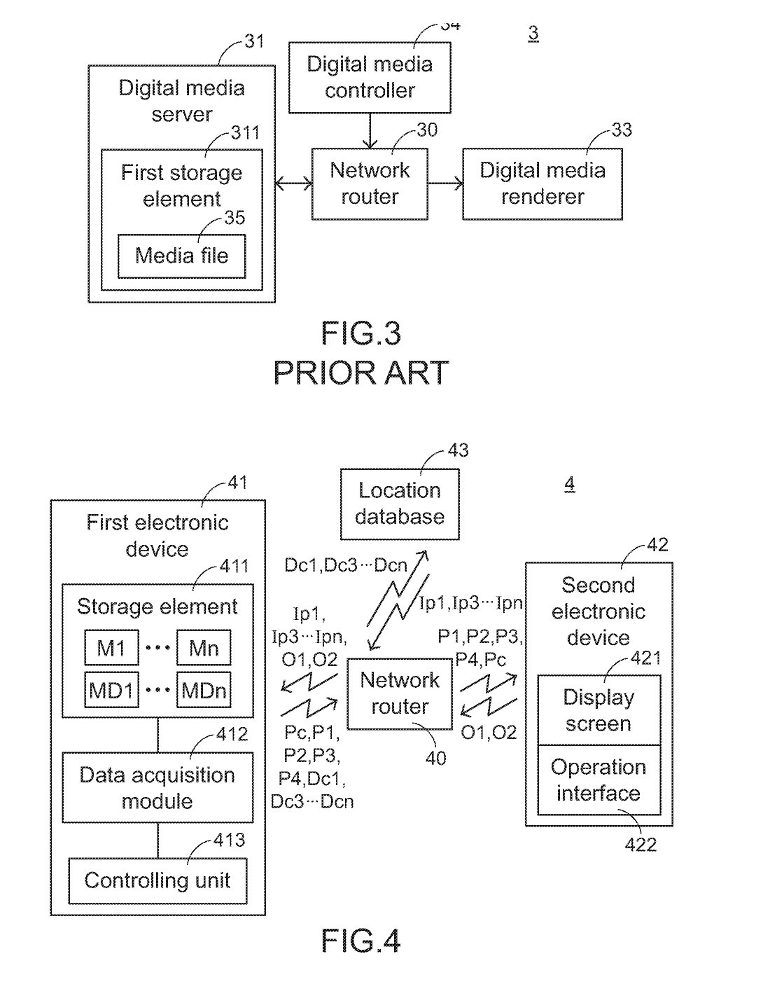

### DETAILED DESCRIPTION OF THE PREFERRED EMBODIMENT

For obviating the drawbacks encountered from the prior art, the present invention provides a photo file displaying method and a Digital Living Network Alliance (DLNA) system using the photo file displaying method.

Hereinafter, a DLNA system of the present invention will be illustrated. FIG. 4 is a schematic functional block diagram illustrating a DLNA system according to a first embodiment of the present invention. As shown in FIG. 4, the DLNA system 4 comprises a network router 40, a first electronic device 41, a second electronic device 42, and a location database 43. The first electronic device 41 comprises a storage element 411, a data acquisition module 412, and a controlling unit 413. The network router 40 is used to provide a network connection function. Via the network router 40, the first electronic device 41 and the second electronic device 42 are connected with each other through network connection. The first electronic device 41 is connected to the network router 40 through network connection. Moreover, plural photo files M1˜Mn are stored in the first electronic device 41. The storage element 411 is included in the first electronic device 41 for storing the plural photo files M1˜Mn. The data acquisition module 412 is connected with the storage element 411 for acquiring coordinate data Dc1, Dc3, . . . , Dcn of the plural photo files M1˜Mn. The controlling unit 413 is connected to the data acquisition module 412. According to the acquiring result of the data acquisition module 412, the controlling unit 413 writes a location information or a no available location information into the metadata MD1˜MDn of the plural photo files M1˜Mn. In this embodiment, the first electronic device 41 is a digital media server, the storage element 411 is a hard disc, the data acquisition module 412 is a firmware component or a hardware component included in the first electronic device 41, and the controlling unit 413 is a microprocessor.

The second electronic device 42 is connected to the network router 40 through network connection. Moreover, via the network router 40, the second electronic device 42 is connected with the first electronic device 41 through network connection. The second electronic device 42 comprises a display screen 421 and an operation interface 422. The plural photo files M1˜Mn stored in the storage element 411 may be displayed on the display screen 421. Via the operation interface 422, the user may operate the plural photo files M1˜Mn in order to generate corresponding operation commands. In this embodiment, the second electronic device 42 is a digital media controller. The display screen 421 and the operation interface 422 are combined as a touch screen. Moreover, the network router 40 complies with the universal plug and play (UPnP) protocol. Moreover, both of the first electronic device 41 and the second electronic device 42 comply with the Digital Living Network Alliance (DLNA) protocol.

The location database 43 is connected to the network router 40 through network connection. Via the network router 40, the location database 43 is connected to the first electronic device 41 through network connection. The location database 43 is used for receiving the coordinate data Dc1, Dc3, . . . , Dcn and converting the Dc1, Dc3, . . . , Dcn into corresponding location information Ip1, Ip3, . . . , Ipn. In this embodiment, the location database 43 is located in a cloud space, but is not limited thereto. In another embodiment, the location database is installed in a computer system. Moreover, the location database 43 may be an existing public map database (e.g. Google maps).

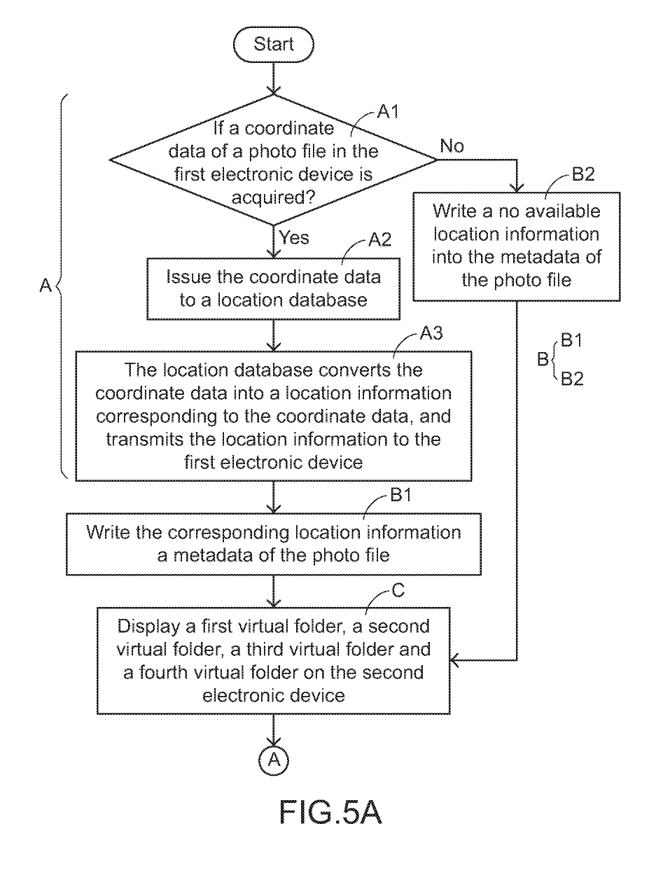

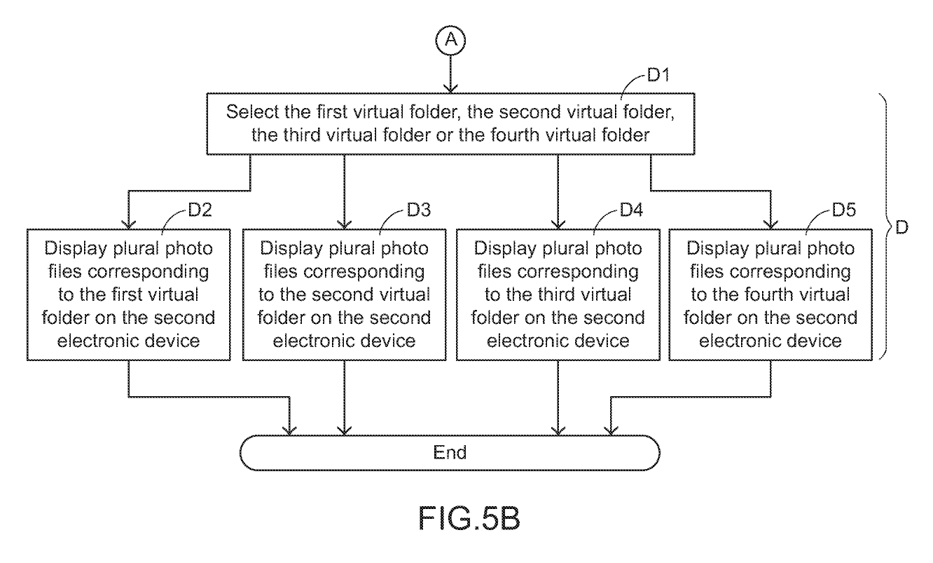

Hereinafter, a photo file displaying method according to the present invention will be illustrated with reference to FIGS. 5A and 5B. FIGS. 5A and 5B are a flowchart illustrating a photo file displaying method according to an embodiment of the present invention. The photo file displaying method comprises the following steps.

Firstly, a step A is performed to judge whether a coordinate data of a photo file in the first electronic device is acquired. In a step B, a location information or a no available location information is written into a metadata of the photo file according to the result of acquiring the coordinate data. In a step C, a first virtual folder, a second virtual folder, a third virtual folder and a fourth virtual folder are displayed on the second electronic device. In a step D, the first virtual folder, the second virtual folder, the third virtual folder or the fourth virtual folder is selected, and the photo file corresponding to selected virtual folder is displayed on the second electronic device.

The step A comprises the following steps A1, A2 and A3. Firstly, the step A1 is performed to judge whether the coordinate data of the photo file in the first electronic device is acquired. If the coordinate data of the photo file of the first electronic device is acquired, the coordinate data is issued to a location database (in the step A2). Then, the coordinate data is converted into a location information corresponding to the coordinate data by the location database, and the location information is transmitted from the location database to the first electronic device (in the step A3).

The step B comprises the following steps B1 and B2. In the step B1, the corresponding location information is written into a metadata of the photo file. In the step B2, the no available location information is written into the metadata of the photo file. The metadata of the photo file describes the data property in order to indicate the storage location, the history data, the resource search, the file record or any other appropriate information. In other words, the metadata is an electronic list for achieving a list editing function. The metadata describes the contents or the features of the photo folder in order to facilitate searching the photo folder.

The step D comprises the following steps D1, D2, D3, D4 and D5. In the step D1, the first virtual folder, the second virtual folder, the third virtual folder or the fourth virtual folder is selected. In the step D2, plural photo files corresponding to the first virtual folder are displayed on the second electronic device. In the step D3, plural photo files corresponding to the second virtual folder are displayed on the second electronic device. In the step D4, plural photo files corresponding to the third virtual folder are displayed on the second electronic device. In the step D5, plural photo files corresponding to the fourth virtual folder are displayed on the second electronic device.

If the judging condition of the step A1 is satisfied, the step A2 is performed. Whereas, if the judging condition of the step A1 is not satisfied, the step B2 is performed. If the first virtual folder is selected in the step D1, the step D2 is performed. If the second virtual folder is selected in the step D1, the step D3 is performed. If the third virtual folder is selected in the step D1, the step D4 is performed. If the fourth virtual folder is selected in the step D1, the step D5 is performed.

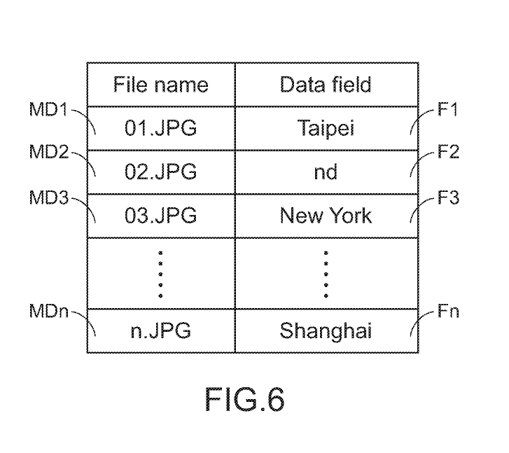

Before the photo file displaying method is started, it is necessary to store the plural photo files M1˜Mn into the storage element 411 of the first electronic device 41. The file names of the plural photo files M1˜Mn are 01.JPG˜n.JPG, respectively (see FIG. 6). The website address of the photo file M1 stored in the first electronic device 41 is http:\\DMS\Photo\01.JPG. The website address of the photo file M2 stored in the first electronic device 41 is http:\\DMS\Photo\02.JPG. The rest may be deduced by analogy. The term “DMS” in the above website addresses denotes the first electronic device 41. The term “Photo” in the above website addresses denotes a default photo folder Fp of the storage element 411. That is, the photo file M1 with the file name “01.JPG” is stored in the photo folder Fp of the first electronic device 41. The rest may be deduced by analogy. The method of storing the plural photo files M1˜Mn into the storage element 411 is well known to those skilled in the art, and is not redundantly described herein.

Hereinafter, the detailed procedure of the photo file displaying method performed by the DLNA system 4 will be illustrated with reference to FIGS. 4 and 5. After the plural photo files M1˜Mn are stored into the storage element 411, the photo file displaying method is started. First of all, the data acquisition module 412 judges whether the coordinate data Dc1, Dc3, . . . , Dcn of the plural photo files M1˜Mn are acquired. That is, the step A1 is performed. The coordinate data Dc1 is stored in the photo file M1 in an exchangeable image file format (EXIF). After the coordinate data Dc1 of the photo file M1 is acquired by the data acquisition module 412, the controlling unit 413 issues the coordinate data Dc1 to the location database 43. That is, the step A2 is performed. Moreover, the coordinate data Dc1 is a global positioning system coordinate data, e.g. (E)121.123456 (N)25.654321.

After the coordinate data Dc1 is received by the location database 43, the coordinate data Dc1 is converted into the location information Ip1 corresponding to the coordinate data Dc1 by the location database 43, and the location information Ip1 is transmitted to the first electronic device. That is, the step A3 is performed. For example, according to the coordinate data Dc1, the location database 43 may realize that the coordinate data Dc1 is associated to a location of Neihu District in Taipei City. Consequently, the coordinate data Dc1 is converted into the location information Ip1 corresponding to Taipei City. In this embodiment, the default item of the location database 43 is “City”, and thus the content of the location information Ip1 is “Taipei”.

After the location information Ip1 is transmitted to the first electronic device 41, the corresponding location information is written into the data field F1 of the metadata MD1 of the photo file M1 (see FIG. 6) by the controlling unit 413. That is, the step B1 is performed. On the other hand, if the data acquisition module 412 judges that no coordinate data of the photo file M2 is acquired, the no available location information is written into the data field F2 of the metadata MD2 of the photo file M2 by the controlling unit 413. That is, the step B2 is performed. In FIG. 6, the no available location information is denoted as “nd”. Similarly, the remaining photo files M3-Mn are subject to the steps A1, A2, A3 and B 1, or subject to the step A1 and B2. After the step A and the step B are performed, the plural metadata MD1˜MDn are obtained (see FIG. 6). As shown in FIG. 6, the photo file M1 has the location information Ip1 corresponding to Taipei, the photo file M3 has the location information Ip3 corresponding to New York, the photo file Mn has the location information Ipn corresponding to Shanghai, and the photo file M2 has no available location information.

After the data fields F1˜Fn of the plural metadata MD1˜MDn are set, if the second electronic device 42 is connected to the first electronic device 41 via the network router 40 through network connection, the plural metadata MD1˜MDn are classified into at least four groups by the controlling unit 413 of the first electronic device 41 according to the data fields F1˜Fn of the plural metadata MD1˜MDn. The photo files having the first location information Ip1 corresponding to Taipei belong the first group. The photo files having the second location information Ip3 corresponding to New York belong to the second group. The photo files having the third location information Ipn corresponding to Shanghai belong to the third group. The photo files having the no available location information belong to the fourth group. According to the above classification, the controlling unit 413 generates a folder packet Pc. The folder packet Pc is transmitted to the second electronic device 42. According to the folder packet Pc, the first virtual folder Fv1, the second virtual folder Fv2, the third virtual folder Fv3 and the fourth virtual folder Fv4 are displayed on the display screen 421 of the second electronic device 42. That is, the step C is performed. The first virtual folder Fv1 contains plural photo files having the first location information. The second virtual folder Fv2 contains plural photo files having the second location information. The third virtual folder Fv3 contains plural photo files having the third location information. The fourth virtual folder Fv4 contains plural photo files having the fourth location information.

Then, in the step D1, if the first virtual folder Fv1 is selected by the user via the operation interface 422 of the second electronic device 42, the second electronic device 42 issues a first select signal O1 to the first electronic device 41. In response to the first select signal O1, the plural photo files having the first location information (including the photo files M1, . . . ) are acquired and formed as a first list packet P1 by the controlling unit 413, and the first list packet P1 is transmitted to the second electronic device 42. In response to the first list packet P1, the plural photo files (including the photo files M1, . . . ) corresponding to the first virtual folder Fv1 are displayed on the display screen 421 of the second electronic device 42. That is, the step D2 is performed. The website address of the photo file M1 displayed on the second electronic device 42 is http:\\DMS\Photo\ first virtual folder\01.JPG.

Whereas, if the second virtual folder Fv2 is selected by the user via the operation interface 422, the second electronic device 42 issues a second select signal O2 to the first electronic device 41. In response to the second select signal O2, the plural photo files having the second location information (including the photo files M3, . . . ) are acquired and formed as a second list packet P2 by the controlling unit 413, and the second list packet P2 is transmitted to the second electronic device 42. In response to the second list packet P2, the plural photo files (including the photo files M3, . . . ) corresponding to the second virtual folder Fv2 are displayed on the display screen 421 of the second electronic device 42. That is, the step D3 is performed. The website address of the photo file M3 displayed on the second electronic device 42 is http:\\DMS\Photo\second virtual folder\03.JPG.

Whereas, if the third virtual folder Fv3 is selected by the user via the operation interface 422, the second electronic device 42 issues a third select signal O3 to the first electronic device 41. In response to the third select signal O3, the plural photo files having the third location information (including the photo files Mn, . . . ) are acquired and formed as a third list packet P3 by the controlling unit 413, and the third list packet P3 is transmitted to the second electronic device 42. In response to the third list packet P3, the plural photo files (including the photo files Mn, . . . ) corresponding to the third virtual folder Fv3 are displayed on the display screen 421 of the second electronic device 42. That is, the step D4 is performed. The website address of the photo file Mn displayed on the second electronic device 42 is http:\\DMS\Photo\third virtual folder\n.JPG.

Whereas, if the fourth virtual folder Fv4 is selected by the user via the operation interface 422, the second electronic device 42 issues a fourth select signal O4 to the first electronic device 41. In response to the fourth select signal O4, the plural photo files having the no available location information (including the photo files M2, . . . ) are acquired and formed as a fourth list packet P4 by the controlling unit 413, and the fourth list packet P4 is transmitted to the second electronic device 42. In response to the fourth list packet P4, the plural photo files (including the photo files M2, . . . ) corresponding to the fourth virtual folder Fv4 are displayed on the display screen 421 of the second electronic device 42. That is, the step D5 is performed. The website address of the photo file M2 displayed on the second electronic device 42 is http:\\DMS\Photo\fourth virtual folder\02.JPG.

Meanwhile, the photo file displaying method of the present invention is completed. In addition, the user may perform a subsequent operation on the selected photo file via the operation interface 422.

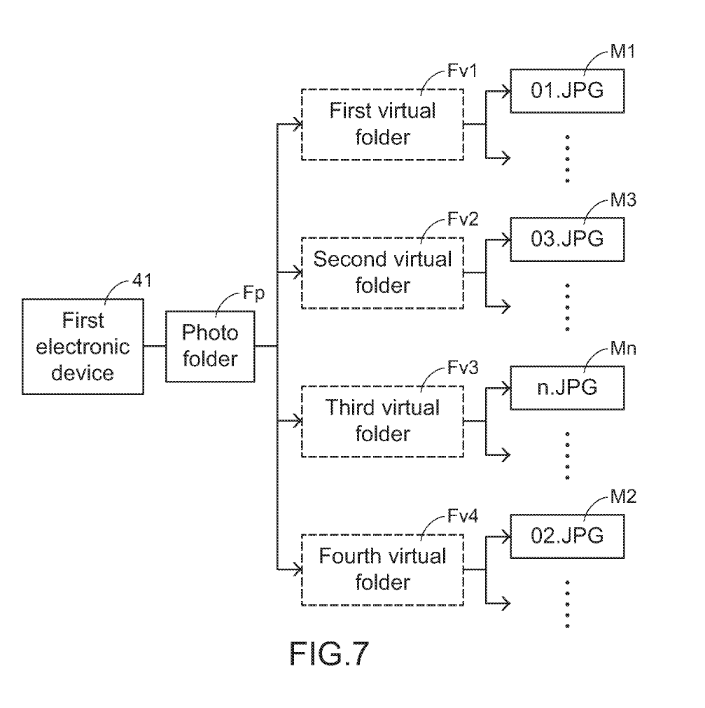

FIG. 7 schematically illustrates the folder architecture of the digital media server of the DLNA system according to the first embodiment of the present invention. The DLNA system 4 of the present invention is capable of classifying the plural photo files M1˜Mn by implementing the photo file displaying method of the present invention. The folder architecture of the first electronic device 41 is clearly shown in FIG. 7. The first storage element 411 of the first electronic device 41 contains the real photo folder Fp. The photo folder Fp contains the first virtual folder Fv1 (indicated by dotted line), the second virtual folder Fv2 (indicated by dotted line), the third virtual folder Fv3 (indicated by dotted line) and the fourth virtual folder Fv4 (indicated by dotted line), which are practically non-existing. That is, the first electronic device 41 only contains the photo folder Fp. For facilitating the user to search the desired photo, the virtual folders Fv1-Fv4 that do not exist in the first electronic device 41 are further displayed on the display screen 421 of the second electronic device 42. Consequently, the photo file displaying method of the present invention is capable of classifying the plural photo files according to the location information. Since the plural photo files with different locations are assigned to different virtual photo folders, the user can easily search the desired photo file.

In the above embodiment of the DLNA system and the photo file displaying method of the present invention, the storage element has the default photo folder. Alternatively, in some other embodiments of the DLNA system and the photo file displaying method of the present invention, the storage element does not have the default photo folder.

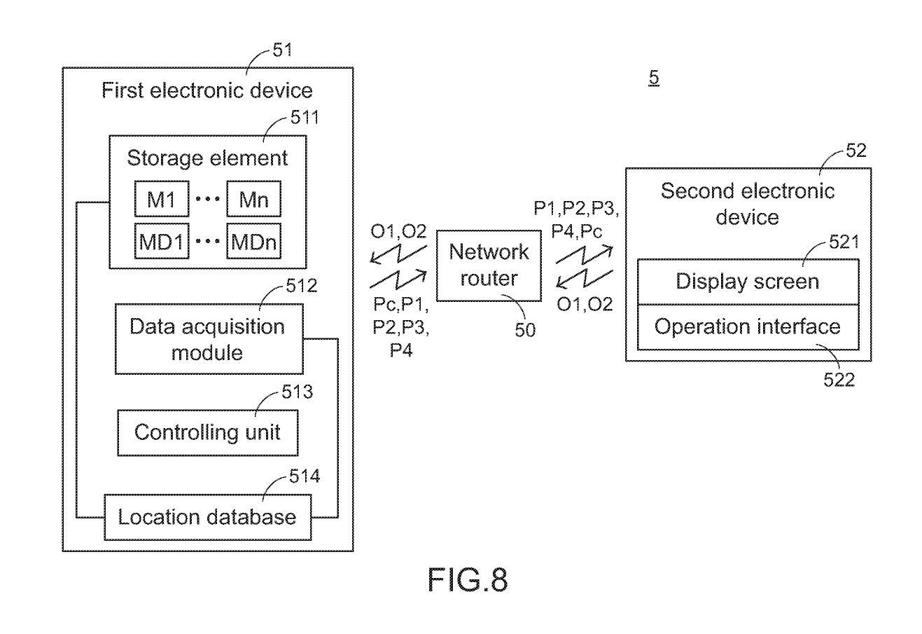

The present invention further provides a second embodiment, which is distinguished from the first embodiment. FIG. 8 is a schematic functional block diagram illustrating a DLNA system according to a second embodiment of the present invention. As shown in FIG. 8, the DLNA system 5 comprises a network router 50, a first electronic device 51 and a second electronic device 52. The first electronic device 51 comprises a storage element 511, a data acquisition module 512, and a controlling unit 513. Except for the following two aspects, the architecture of the DLNA system 5 of this embodiment is identical to the architecture of the DLNA system 4 of the first embodiment, and is not redundantly described herein. Firstly, the first electronic device 51 further comprises a location database 514. The location database 514 is connected with the data acquisition module 512 and the storage element 511. The location database 514 is used for receiving the coordinate data Dc1, Dc3, . . . , Dcn and converting the Dc1, Dc3, . . . , Dcn into corresponding location information Ip1, Ip3, . . . , Ipn. In other words, the first electronic device 51 has the built-in location database 514. The procedure of acquiring the location information is implemented in the first electronic device 51. Secondly, the second electronic device 52 is a digital media player.

From the above descriptions, the present invention provides a DLNA system and a photo file displaying method. According to the result of acquiring the coordinate data, the metadata of plural photo files are set. When the user operates an electronic device to browse plural photo files, the metadata are classified into plural groups, and plural virtual folders are displayed on the electronic device according to the classification. Each of the virtual folders contains the photo folders having the location information corresponding to the metadata. Consequently, plural photo files with the same location information are assigned to the same virtual folder. In other words, the photo file displaying method of the present invention may facilitate the user to browse the plural photo files and easily search the desired photo file.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A photo file displaying method for a DLNA system, the photo file displaying method comprising steps of:
(A) judging whether a coordinate data of a photo file in a first electronic device is acquired;
(B) writing a location information or a no available location information into a data field of a metadata of the photo file according to a result of acquiring the coordinate data;
(C) displaying a first virtual folder and a second virtual folder on a second electronic device, wherein if the photo file has the location information, the photo file is assigned to the first virtual folder, wherein if the photo file has the no available location information, the photo file is assigned to the second virtual folder; and
(D) if the first virtual folder or the second virtual folder is selected, displaying the photo file corresponding to the first virtual folder or the second virtual folder on the second electronic device.

2. The photo file displaying method according to claim 1, wherein the step (A) comprises steps of:
(A1) judging whether the coordinate data of the photo file is acquired;
(A2) if the coordinate data is acquired, issuing the coordinate data to a location database; and
(A3) the location database converting the coordinate data into a location information corresponding to the coordinate data, and transmitting the location information to the first electronic device.

3. The photo file displaying method according to claim 1, wherein if the coordinate data of the photo file in the first electronic device is acquired, the step (B) is performed by writing the location information into the data field of the metadata, wherein if the coordinate data of the photo file in the first electronic device is not acquired, the step (B) is performed by writing the no available location information into the data field of the metadata.

4. The photo file displaying method according to claim 1, wherein the step (D) comprises steps of:
(D1) if the first virtual folder is selected, displaying the photo file corresponding to the first virtual folder on the second electronic device; and
(D2) if the second virtual folder is selected, displaying the photo file corresponding to the second virtual folder on the second electronic device.

5. The photo file displaying method according to claim 1, wherein the first electronic device is a digital media server according to a DLNA protocol, and the second electronic device is a digital media controller or a digital media player according to the DLNA protocol.

6. A DLNA system for displaying a photo file, the DLNA system comprising:
a network router providing a network connection function;
a digital media server connected to the network router through network connection and storing the photo file, wherein the digital media server comprises a storage element, a data acquisition module and a controlling unit, wherein the storage element is disposed within the digital media server, and the photo file is stored in the storage element, wherein the data acquisition module is connected with the storage element so as to acquire a coordinate data of the photo file, wherein the controlling unit is connected with the data acquisition module, and the controlling unit writes a location information or a no available location information into a metadata of the photo file according to a result of acquiring the coordinate data by the data acquisition module, wherein if the photo file has the location information, the photo file is assigned to a first virtual folder, wherein if the photo file has the no available location information, the photo file is assigned to a second virtual folder; and
an electronic device connected to the network router through network connection and connected to the digital media server via the network router through network connection, wherein the first virtual folder and the second virtual folder are displayed on the electronic device, wherein if the first virtual folder or the second virtual folder is selected, the photo file corresponding to the first virtual folder or the second virtual folder is displayed on the electronic device.

7. The DLNA system according to claim 6, wherein if the coordinate data of the photo file is acquired by the data acquisition module, the controlling unit writes the location information into a data field of the metadata, wherein if the coordinate data of the photo file is not acquired by the data acquisition module, the controlling unit writes the no available location information into the data field of the metadata.

8. The DLNA system according to claim 6, wherein the DLNA system further comprises a location database, wherein the location database is connected to the network router through network connection and connected to the digital media server via the network router through network connection, wherein after the coordinate data is received by the location database, the location database converts the coordinate data into the location information, wherein after the location information is obtained by the location database, the location information is transmitted to the digital media server.

9. The DLNA system according to claim 8, wherein the location database is installed in a cloud space or a computer system, wherein after the location information is obtained by the location database, the location information is transmitted to the storage element, so that the controlling unit writes the location information into a data field of the metadata.

10. The DLNA system according to claim 6, wherein the digital media server further comprises a location database, wherein the location database is connected to the data acquisition module and the storage element, wherein after the coordinate data is received by the location database, the location database converts the coordinate data into the location information, wherein after the location information is obtained by the location database, the location information is transmitted to the storage element, so that the controlling unit writes the location information into a data field of the metadata.

11. The DLNA system according to claim 6, wherein if the first virtual folder is selected, the photo file having the location information is acquired and formed as a first list packet by the controlling unit, and the first list packet is transmitted from the controlling unit to the electronic device, so that the photo file corresponding to the first virtual folder is displayed on the electronic device, wherein if the second virtual folder is selected, the photo file having the no available location information is acquired and formed as a second list packet by the controlling unit, and the second list packet is transmitted from the controlling unit to the electronic device, so that the photo file corresponding to the second virtual folder is displayed on the electronic device.
